(19) United States
(12) Patent Application Publication
(10) Pub. No.: US 2009/0292569 A1
(43) Pub. Date: Nov. 26, 2009

(54) Method for sweeping a depository and an automated teller machine incorporating the same

(76) Inventors: Scott R. Statland, Mequon, WI (US); Penny Jurss, Hartford, WI (US)

Correspondence Address: Visa USA c/o Duane Morris LLP;Attn: James Sze, Esq., 101 West Broadway, Suite 900, San Diego, CA, 92101, US

(21) Appl. No.: 12/154,495

(22) Filed: May 23, 2008

(51) Int. Cl. G06F 17/30; G06Q 10/00

(52) U.S. Cl. 705/7; 705/1

(57) ABSTRACT

Disclosed herein is a method for collecting information related to deposits made at an ATM and an ATM configured for collected the same. Information describing each deposit made at the ATM is collected and first and second summaries of the deposits produced. In response to a sweep command, a printout summarizing deposits made prior to the sweep command and subsequent to an immediately preceding sweep command is generated while, in response to a reset command, a printout summarizing deposits made prior to the reset command but subsequent to the sweep command is generated.

### FIELD OF THE DISCLOSURE

The present disclosure relates to processes for managing automated teller machines (ATMs) and, more particularly, processes capable of enabling partial settlements of ATMs and/or expediting clearance of non-cash deposits made thereat.

### BACKGROUND

Over the years, the use of ATMs to conduct financial transactions has become increasingly prevalent. The most common types of financial transactions which are conducted using an ATM are: (a) the withdrawal of funds from a selected account; (b) the deposit of funds into a selected account; (c) the transfer of funds between accounts; and (d) the deposit and/or transfer of funds for application to a payment due on a selected account. In order to accurately track the various financial transactions conducted at an ATM, the bank or other financial institution maintaining the ATM must periodically reconcile or “settle” the ATM by performing a series of cash management transactions which enable the bank or other financial institute to compare the electronic records, generated by the ATM, describing the financial transactions conducted thereat with the actual withdrawals of cash from and deposits of checks and/or checks into the ATM.

Traditionally, ATM settlements have addressed all of the financial transactions performed thereby. Recently, however, the all-encompassing nature of the settlement process has become inconsistent with the needs of the banking industry. Many financial institutions now employ third parties that replenish the cash dispensed by their ATMs but do not handle the deposits made at the ATM. Rather, as deposits require an entirely separate accounting procedure, it is more common for an employee of the bank or other financial institution maintaining the ATM to remove the deposits from the ATM. Furthermore, government regulations now limit the period of time that banks and other financial institutions are permitted to process checks and, once the permitted time period has expired, the account holder must be given unrestricted access to the funds deposited by check. To avoid losses resulting from checks dishonored by the bank or other financial institution on which they are drawn, it is important that checks are processed without delay. For this reason, it is common for deposits to be removed from ATMs on a daily basis. However, many ATMs do not need to be replenished with cash on a daily basis. This is particularly true for less busy ATMs, for example, those at infrequently travelled locations. For these and other reasons, it would be advantageous if ATMs were capable of being partially settled, e.g., if it was possible to settle some of the financial transactions, for example, deposits of checks but not settle other financial transactions, for example, deposits or withdrawals of cash.

Also, ATMs have become increasingly sophisticated in recent years. For example, in the past, ATMs were only able to confirm that an envelope had been physically deposited therein. No other information regarding the deposit was available. In contrast, ATMs are now able to maintain much more detailed information regarding deposits. For example, an ATM may now maintain a record of the total amount of cash contained in the deposits made at the ATM, the denomination of the deposited bills, the total number of checks included in the deposits made at the ATM and the total dollar amount of the checks. As increasingly greater levels of detail become available, more specialized accounting processes have become possible. However, the development and implementation of specialized accounting processes is handicapped considerably by the conventional process by which ATMs are settled. Accordingly, the development of specialized accounting processes would be greatly facilitated by the development of a process to partially settle an ATM.

For the foregoing reasons, it is contemplated that it would be advantageous to configure an ATM in a manner which enables partial settlements thereof. Accordingly, disclosed herein is such a system and method.

### SUMMARY

In one embodiment, an automated teller machine (ATM) is comprised of a depository and a memory subsystem which includes first and second memory spaces. The first memory space stores data describing deposits conducted subsequent to a first sweep of the depository and prior to a second sweep of the depository of the ATM while the second memory space stores data describing deposits conducted subsequent to a first reset of the ATM and prior to the second sweep of the depository. In one aspect, the ATM further includes a processor subsystem configured to sum the contents of the first memory space with the contents of the second memory space and store the sum in the second memory space and, in another, the ATM further includes a user interface for entering data describing deposits into the depository, initiating sweeps of the depository and initiating resets of the ATM.

In still another aspect of this embodiment, the first memory space includes first, second and third memory sub-spaces. Data describing envelope deposits conducted subsequent to the first sweep of the depository and prior to the second sweep of the depository is stored in the first memory sub-space, data describing non-envelope check deposits conducted subsequent to the first sweep of the depository and prior to the second sweep of the depository is stored in the second memory sub-space and data describing non-envelope cash deposits conducted subsequent to the first sweep of the depository and prior to the second sweep of the depository is stored in the third memory sub-space. In further accordance with this aspect, the second memory space further includes a first memory sub-space for storing data describing envelope deposits conducted subsequent to the first reset of the ATM and prior to the second sweep of the ATM is stored, a second memory sub-space for storing data describing non-envelope check deposits conducted subsequent to the first reset of the ATM and prior to the second sweep of the ATM is stored and a third memory sub-space for storing data describing non-envelope cash deposits conducted subsequent to the first reset of the ATM and prior to the second sweep of the ATM.

Further, the third memory sub-space of the first memory space may be comprised of eight memory sub-sub-spaces. Of the eight, the first memory sub-sub-space stores data describing the total amount of cash deposited subsequent to the first sweep of the depository and prior to the second sweep of the depository while the second through eighth memory sub-sub spaces are used to store data identifying the total number of one hundred, fifty, twenty, ten, five, two and one dollar bills, respectively, deposited subsequent to the first sweep of the depository and prior to the second sweep of the depository. Similarly, the third memory subspace of the second memory space may be comprised of eight memory sub-sub-spaces. Here, data describing the total amount of cash deposited subsequent to the first reset of the ATM and prior to the second reset of the ATM is stored in the first memory sub-sub space while data describing the total number of one hundred, fifty, twenty, ten, five and one dollar bills deposited subsequent to the first reset of the ATM and prior to the second sweep of the depository stored in the second, third, fourth, fifth, sixth, seventh and eighth memory sub-sub-spaces, respectively.

In another embodiment, claimed herein is a computer system for use in conjunction with an automated teller machine (ATM). The computer system is comprised of a memory subsystem, a processor subsystem, a bus subsystem for coupling the processor subsystem to the memory subsystem and a software module stored in the memory subsystem and executable by the processor subsystem. For each deposit made at the ATM, the processor subsystem stores information related to the deposit in a first memory space which forms part of the memory subsystem. Upon receipt of a command from the processor subsystem, the software module will sweep at least a portion of the first memory space by summing the swept portion of the first memory space with a corresponding portion of a second memory space, store the sum in the corresponding portion of the second memory space and clear the contents of the swept portion of the first memory space.

One such command is a full sweep command. Upon receipt of a full sweep command, the software module sums the contents of the first memory space with the contents of the second memory space, stores the sum in the second memory space and clears the contents of the first memory space. Another such command is a partial sweep command. Upon receipt of a partial sweep command, the software module sums the contents of a selected portion of the first memory space with the contents of a corresponding portion of the second memory space, stores the sum in the corresponding portion of second memory space and clears the contents of the corresponding portion of the first memory space.

In aspects thereof, the computer system may include an output device coupled to the bus subsystem. In one such aspect, upon receipt of the full sweep command, the software module generates a first output describing the contents of the first memory space and transfers the first output to the output device for generation of a message describing the contents of the first memory space. In another, upon receipt of the partial sweep command, the software module generates a first output describing the contents of the selected portion of the first memory space and transfers the first output to the output device for generation of a message describing the contents of the selected portion of the first memory space. Variously, the first selected portion of the first memory space may describe (1) all envelopes deposits made prior to issuance of the partial sweep command and subsequent to issuance of an immediately preceding partial or full sweep command; (2) all non-envelope check deposits made prior to issuance of the partial sweep command and subsequent to issuance of an immediately preceding partial sweep or full sweep command; or (3) all non-envelope bill deposits made prior to issuance of the partial sweep command and subsequent to issuance of an immediately preceding partial or full sweep command.

In other aspects thereof, the software module may generate different outputs in response to the type of partial sweep command received thereby. Specifically, upon receipt of a first type of partial sweep command, the software module generates a second output describing the contents of a first selected portion of the first memory space, transfers the second output to the output device for generation of a message describing the contents of the first selected portion of the first memory space, sums the contents of the first selected portion of the first memory space with a corresponding first portion of the second memory space, stores the sum in the corresponding first portion of the second memory space and clears the contents of the first selected portion of the first memory space.

Similarly, upon receipt of a second type of partial sweep command, the software module generates a third output describing the contents of a second selected portion of the first memory space, transfers the third output to the output device for generation of a message describing the contents of the second selected portion of the first memory space, sums the contents of the second selected portion of the first memory space with a corresponding second portion of the second memory space, stores the sum in the corresponding second portion of the second memory space and clears the contents of the second selected portion of the first memory space.

Finally, upon receipt of a third type of partial sweep, the software module generates a fourth output describing the contents of a third selected portion of the first memory space, transfers the fourth output to the output device for generation of a message describing the contents of the third selected portion of the first memory space, sums the contents of the third selected portion of the first memory space with a corresponding third portion of the second memory space, stores the sum in the corresponding third portion of the second memory space and clears the contents of the third selected portion of the first memory space.

In further accordance herewith, the first, second and third selected portions of the first memory space may describe all envelopes deposits made prior to issuance of the partial sweep command and subsequent to issuance of an immediately preceding partial or full sweep command, all non-envelope check deposits made prior to issuance of the partial sweep command and subsequent to issuance of an immediately preceding partial or full sweep command and all non-envelope bill deposits made prior to issuance of the partial sweep command and subsequent to issuance of an immediately preceding partial or full sweep command, respectively.

In another embodiment, claimed herein is a computer system for use in conjunction with an automated teller machine (ATM). In this embodiment, the computer system is comprised of a processor subsystem. a memory subsystem, a bus subsystem, an output device, a first software module and a second software module. For each deposit made at the ATM, the processor subsystem stores information related to the deposit in the first memory space. Variously, the first software module may generate an output in response to either a full sweep command or a partial sweep command. In response to a full sweep command, the first software module generates a first output describing the contents of the first memory space, transfers the first output to the output device for generation of a message describing the contents of the first memory space, sums the contents of the first memory space with the contents of the second memory space, stores the sum in the second memory space and clears the contents of the first memory space. Conversely, in response to receipt of a partial sweep command, the first software module generates a second output describing the contents of a selected portion of the first memory space, transfers the second output to the output device for generation of a message describing the contents of the selected portion of the first memory space, sums the contents of the selected portion of the first memory space with the contents of a corresponding portion of the second memory space, stores the sum in the corresponding portion of the second memory space and clears the contents of the corresponding portion of the first memory space. In contrast, in response to receipt of a reset command, the second software module generates a second output describing the contents of the second memory space, transfers the second output to the output device for generation of a message describing the contents of the second memory space and clears the contents of the second memory space.

In still yet another embodiment, claimed herein is a software program comprised of first and second sets of instructions, each encoded in a memory subsystem and executable by a processor subsystem of an automated teller machine (ATM). Execution of the first set of instructions causes the processor subsystem to generate, from information stored at a first location in the memory subsystem, a first output comprised of a summary of all deposits at the ATM subsequent to an immediately preceding execution of the first set of instructions while execution of the second set of instructions causes the processor subsystem to generate, from information stored at a second location in the memory subsystem, a second output comprised of a summary of all deposits at the ATM that are both prior to the execution of the second set of instructions and subsequent to the execution of the first set of instructions. Execution of the first set of instructions further causes the processor subsystem to replace the deposit information stored at the second location with the combination of the deposit information stored at the first location and the deposit information stored at the second location. Execution of the second set of instructions, on the other hand, further causes the processor subsystem to clear the contents of the second memory location.

In still another embodiment, claimed herein is a method for collecting information related to deposits made at an ATM. In accordance therewith, information describing each deposit made at the ATM is collected and a first summary of deposits produced from the collected information. The first summary of deposits is updated each time that a deposit is made at the ATM and an output comprised of a selected portion of the first summary of deposits generated. The selected portion is deleted from the summary of deposits and a second summary of deposits produced from the deleted portions of the first summary of deposits. The second summary of deposits is updated each time that a portion of the first summary of deposits is deleted and a second output comprised of the second summary of deposits generated.

The first summary of deposits may be comprised of first, second and third sections and generating an output of a selected portion of the first summary of deposits may encompass the generation of an output comprised of one or more of the first, second and third sections of the first summary of deposits. Variously, the first section of the first summary of deposits describes envelope deposits made at the ATM, the second section of the first summary describes non-envelope check deposits made at the ATM and the third section of the first summary describes non-envelope cash deposits made at the ATM.

### DESCRIPTION OF THE DRAWINGS

For a more complete understanding of the teachings set forth herein, and for further details thereof, reference is now made to the drawings accompanying this disclosure, in which:

FIG. 1 is a front view of an ATM configured in a manner which enables partial settlements of deposits;

FIG. 2 is a block diagram of selected components of the ATM of FIG. 1;

FIG. 3A is a block diagram illustrating initial deposit information maintained in a memory subsystem of the ATM of FIGS. 1-2;

FIG. 3B is a block diagram illustrating deposit information maintained in the memory subsystem of FIG. 3A after a first series of deposits are conducted at the ATM of FIGS. 1-2;

FIG. 3C is a block diagram illustrating deposit information maintained in the memory subsystem of FIG. 3B after completion of a “sweep all checks” transaction;

FIG. 3D illustrates a printout generated by the ATM of FIGS. 1-2 upon completion of the “sweep all checks” transaction;

FIG. 3E is a block diagram illustrating deposit information maintained in the memory subsystem of FIG. 3C after completion of a “sweep all envelopes” transaction;

FIG. 3F illustrates a printout generated by the ATM of FIGS. 1-2 upon completion of the “sweep all envelopes” transaction;

FIG. 3G is a block diagram illustrating deposit information maintained in the memory subsystem of FIG. 3E after a second series of deposits are conducted at the ATM of FIGS. 1-2;

FIG. 3H is a block diagram illustrating deposit information maintained in the memory subsystem of FIG. 3G after completion of a “sweep all” transaction;

FIG. 3I illustrates a printout generated by the ATM of FIGS. 1-2 upon completion of the “sweep all” transaction;

FIG. 3J is a block diagram illustrating deposit information maintained in the memory subsystem of FIG. 3H after a third series of deposits are conducted at the ATM of FIGS. 1-2; and

FIG. 3K is a block diagram illustrating deposit information maintained in the memory subsystem of FIG. 3J after a “totals reset” transaction.

### NOTATION AND NOMENCLATURE

To facilitate an understanding of the description and claims which follow, a brief discussion of the terms used herein shall now be provided.

As used herein, the term “sweep” refers to a process in which a record of deposits made at the ATM over a period of time is obtained. A “sweep” process may be further characterized as a “sweep envelopes”, “sweep checks”, “sweep cash” or “sweep all” process.

The term “sweep envelopes” refers to a process in which a record of all envelopes deposited at the ATM over a specified period of time is obtained.

The term “sweep checks” refers to a process in which a record of all checks deposited at the ATM without the use of envelopes over a specified period of time is obtained.

The term “sweep cash” refers to a process in which a record of all cash deposited at the ATM without the use of envelopes over a specified period of time is obtained.

The term “sweep all” refers to a process in which a record of all envelopes, checks deposited without the use of envelopes and cash deposited without the use of envelopes over a specified period of time is obtained.

The term “totals reset” refers to a process in which a record of deposits swept over a specified period of time is obtained.

### DETAILED DESCRIPTION

The teachings set forth herein are susceptible to various modifications and alternative forms, specific embodiments of which are, by way of example, shown in the drawings and described in detail herein. It should be clearly understood, however, that the drawings and detailed description set forth herein are not intended to limit the disclosed teachings to the particular form disclosed. On the contrary, the intention is to cover all modifications, equivalents and alternatives falling within the spirit and scope of that which is defined by the claims appended hereto.

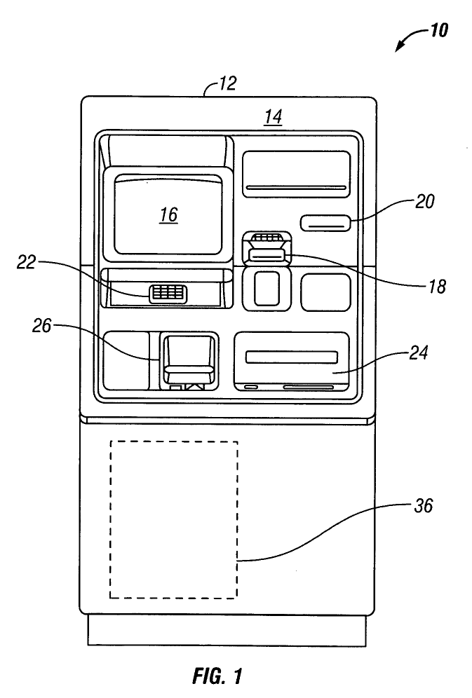

Turning first to FIG. 1, an automated merchant banking apparatus 10, for example, an ATM may now be seen. The ATM 10 includes a housing 12 in which the various components of the ATM 10 reside. It should be clearly understood that the description of the ATM 10 which follows hereinbelow is greatly simplified and that numerous details not necessary for an understanding of the process and associated structure which enables partial settlements of the ATM 10 have been omitted for ease of description. Further details regarding the operation of ATMs may be obtained from any number of references, for example, US 2007/0226142 A1 to Hanna et al., which is hereby incorporated by reference as if reproduced in its entirety.

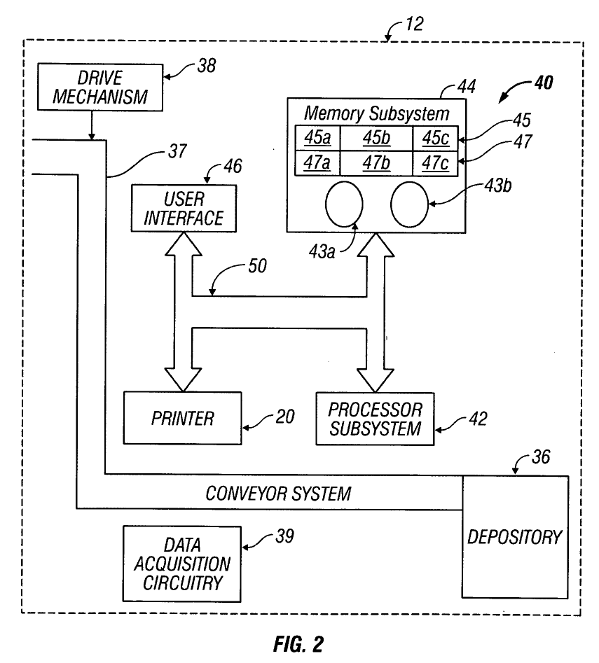

The ATM 10 includes a front surface 14 having plural openings through which a number of interface devices are accessible to authorized users, for example, those persons having both an account with the bank or other financial institution owning and/or operating the ATM 10 (or, in the alternative, an account with a bank or other financial institution electronically linked to the ATM 10) and an access card (not shown) which enables the authorized user to perform any number of common banking functions, for example, depositing funds into and withdrawing funds from their account. The interface devices include video screen 16, card reader 18, printer 20, keypad 22, cash dispenser 24 and depository access door 26. The video screen 16 serves as a display which provides information and/or instructions to users of the ATM 10. For example, internal processing circuitry, for example, processor subsystem 42 of FIG. 2, of the ATM 10 may generate a display (a) inquiring as to the banking function to be conducted, (b) instructing the user to insert funds to be deposited into a designated account to be inserted into depository 36 after the depository access door 26 opens or (c) instructing the user to wait while the requested transaction is being processed. Of course, the foregoing is provided purely by way of example and it is fully contemplated that a wide variety of other displays may be generated by the processor subsystem 42.

Variously, the video screen 16 may form part of a conventional cathode ray tube (CRT) type display, a flat-screened liquid crystal diode (LCD) type display or a touch screen. If embodied as a touch screen, it is further contemplated that the user will be capable of issuing instructions for selecting, controlling or otherwise guiding execution of a banking transaction by touching or otherwise applying pressure to selected locations on the touch screen, thereby generating one or more manual inputs for transmission to the processor subsystem 42. Of course, rather than employing the more costly touch screen, some ATMs employ a series of keys, typically placed on the periphery of the video screen 16, for use in generating the aforementioned manual inputs to be transmitted to the processor subsystem 42. While it is fully contemplated that any type of information may be transmitted to the processor subsystem 42 using the touch screen and/or keys, most commonly, they are used to advise the processor subsystem 42 as to the type of transaction, e.g., deposit, withdrawal or transfer, to be conducted.

To initiate a transaction, information encoded on the access card is transmitted to the processor subsystem 42. While it is contemplated that a wide variety of access cards are suitable for use, most common are those cards in which the information is encoded on a magnetic strip fixedly attached to one side of the access card. Further, while the information encoded on the access card tends to vary depending on the particular type of access card, access cards typically include information identifying the user of the access card, the account or accounts to which the user is permitted access to and security information such as a 1 character pin verification key indicator (PVKI) or a 4-character pin verification value (PVV). To transmit the information encoded on the access card to the processor subsystem 42, the user inserts the access card into or, in the alternative, swipes the access card through, a slot formed in the card reader 18, thereby enabling the card reader 18 to extract the desired information from the access card. Using the extracted information, the identity of the user is verified and the ATM 10 initiates a transaction, for example, by the processor subsystem 42 generating, on the video screen 16, a list of transactions available for selection by the user.

The printer 20 or other type of output device generates a summary of each transaction conducted at the ATM 10 in a tangible medium, for example, a sheet of paper, which may be saved, by the user, for later use, for example, to record a cash withdrawal from the balance of a checking account owned by the user. Typically, the printer 20 is controlled by the processor subsystem 42 which, upon completing the transaction selected by the user, issues a series of instructions to the printer 20 to generate a description of the transaction in accordance with a predetermined format. For example, if the transaction initiated by the user is a withdrawal of cash from a checking account owned by the user operating the ATM 10, the description of the transaction generated by the printer 20 may include the following information:

Withdrawal: $100;

From: Checking;

Account No.: 123-456-789; and

Balance: $1,000.00.

Here, the first line advises the user as to the amount of money withdrawn from an unspecified account owned thereby; the second line advises the user as to whether the user accessed cash in their checking, savings or other type of account, the third line advises the user as to the account number for the account from which the indicated amount of money was withdrawn and the fourth line advises the user as to the amount of cash remaining within the account after completion of the identified transaction. Of course, the foregoing description is provided purely by way of example and it should be clearly understood that both the type of data formats employed and the type of information included thereon may vary depending on the type of transaction conducted, the information that the owner and/or operator of the ATM 10 has selected for transmission to the user, or both.

Manual inputs from the user of the ATM 10 are transferred to the processor subsystem 42 by the keypad 22. While in some ATMs, in particular, older ATMs still in service, the keypad 22 is the sole device capable of generating user inputs for transfer to the processor subsystem 42, in many ATMs, the keypad 22 is employed in conjunction with at least one other source of user inputs. For example, for ATMs having a touch screen, the user may select the type of transaction using the touch screen and then select the amount of the transaction using the keypad 22. Many, but not necessarily all, ATM keypads such as the keypad 22 have a 12-key (10 numeric and 2 function) keyset similar to that employed in commercially available telephones. Of course, the configuration of the keypad 22 may vary from that described herein, particularly if the ATM 10 includes functionality enabling the user to perform other, often more sophisticated transactions than those currently associated with ATMs.

Referring next to FIG. 2, additional components of the ATM 10 will now be described in greater detail. In this regard, it should again be noted that FIG. 2 has been greatly simplified for ease of description and that numerous components of the ATM 10 that reside within the housing 12 but are not believed to be necessary for an understanding of the present disclosure have been omitted. It should be further noted that, while FIG. 2 shows user interface 46 as residing within the housing 12, it should be noted that, as used in the disclosure, the term “user interface” is intended to refer to a single component or, in the alternative, collectively refer to plural components, such as one or more of the keypad 22, any keys deployed around the periphery of the video screen 16, the video screen 16 (if configured as a touch screen) or any other device, accessible to the user, with which the user is capable of issuing commands to the processor subsystem 42. Moreover, the term “user interface” further encompasses any electronic circuitry, electrical connections or the like employed to couple one or more of the aforementioned devices to the bus subsystem 50. Finally, it should be noted that, while the printer 20 typically resides within the housing 12, selected components thereof may not. For example, a portion of the feed mechanism of the printer 20 may be positioned outside of the housing 12 so that the record of the transaction may be readily delivered to the user.

Conveyor system 37 is responsible for transporting envelopes, checks and currency inserted through then depository access door 26 to the depository 36 where the envelopes, checks and currency are stored until removed from the depository 36, for example, during a partial or full sweep of the ATM 10, the execution of which enables the partial settlement of the ATM 10. Similarly, the drive mechanism 38 assists in propelling the inserted envelopes, checks and currency onto and/or along the conveyor system 37. It is contemplated that the drive mechanism 38 and/or the conveyor system 37 may be activated variously. For example, upon the user indicating that a deposit is to be initiated, one or both of the conveyor system 37 and the drive mechanism 38 may be activated by either an instruction issued by the user interface 46 or the processor subsystem 42.

At this point, it should be noted that the nature of the deposit made by the user may vary depending on the configuration of the ATM 10. Traditionally, ATMs have only accepted envelopes containing any number of checks, bills of the same or various denominations or any combination thereof. However, newer ATMs that are not yet widely distributed permit a wider range of deposits. More specifically, in addition to accepting envelopes carrying checks and/or cash which total an amount indicated by the user, newer ATMs allow a user to insert a single check into the ATM without the use of an envelope. Such ATMs further allow the user to insert, one by one, a series of checks into the ATM without use of an envelope. Finally, such ATMs still further allow the user to insert bills into the ATM, again, without the use of an envelope. As used herein, the term “non-envelope check deposit” shall refer to the deposit of a check in an ATM without the use of an envelope.” While the term “non-envelope cash deposit” shall refer to the deposit of cash in an ATM without the use of an envelope.

Also forming a part of the ATM 10 is data acquisition circuitry 39. The data acquisition circuitry 39 is positioned along the conveyor system 37 and collects information from deposited the items, most commonly, checks and/or bills, as they are being transported to the depository 36. It is contemplated that the data acquisition circuitry 39 may include an optical scanner or other device capable of collecting information from the deposited items as they pass by the data acquisition circuitry 39. For example, the data acquisition circuitry 39 may be configured to identify the denomination of each bill individually deposited into the ATM 10 by the user. A suitable technique to identify the denomination of each bill would be for the data acquisition circuitry 39 to scan the image of the bill as it passes by and then compare the scanned image to images of bills currently in circulation. Similarly, the data acquisition circuitry 39 may be configured to determine the value of each check individually deposited into the ATM 10 by the user. Here, a character recognition technique in which the numbers and/or letters appearing on the check are identified and, based upon the identified numbers and/or letters, the amount of the check determined. Of course, the data acquisition circuitry 39 may be used to collect still other information related to deposits made at the ATM 10. For example, the data acquisition circuitry 39 may scan checks as they are transported to the depository 36 in order to determine if the check has been imprinted in a manner indicating that the check had been previously submitted for payment.

In the embodiment disclosed herein, it is contemplated that information related to deposits that is collected for later use during a partial or full settlement of the ATM 10 is collected from the user interface 46. More specifically, for each envelope containing one or more checks or bills that is deposited in the ATM 10, the information related to the deposit that is processed or otherwise maintained for later use during settlement of the ATM 10 is: (a) that an envelope has been deposited in the ATM 10; and (b) the cash value of the checks and/or currency placed in the envelope. For non-envelope check deposits made at the ATM 10, the information related to the deposit that is processed or otherwise maintained for later use during settlement of the ATM 10 is: (a) that a check has been deposited in the ATM 10 and (b) the value of the check deposited in the ATM 10. Finally, for non-envelope cash deposits made at the ATM 10, the information related to the deposit that is processed or otherwise maintained for later use during settlement of the ATM 10 is: (a) that a bill has been deposited in the ATM 10 and (b) the denomination of the bill.

For envelope and non-envelope check deposits, the desired information may be readily acquired from the information entered at the user interface 46 during the transaction. For example, in response to a first inquiry asking, most commonly, in the form of a question appearing on the video screen 16, the type of deposit, e.g., envelope, non-envelope check or non-envelope cash, to be made, the user may indicate that either an individual check or envelope is being deposited in the ATM 10, for example, by depressing an appropriate button on the keypad 22. In response to a second, subsequent, inquiry which asks, again, most commonly, in the form of a question appearing on the video screen 16, the amount of the deposit to be made, the user may indicate the cash value of the deposit to be made, again, for example, using the keypad 22. Upon receiving the response to the second inquiry, the depository access door 26 opens, thereby enabling the user to insert the envelope or individual check into the ATM 10.

The manner by which the desired information is acquired for cash deposits is, however, less apparent. In a manner similar to that previously set forth, in response to the first and second inquiries, the user may again indicate that the deposit is comprised of a specified amount of cash. As before, the depository access door 26 may open upon receipt of a reply to the second inquiry. Here, however, the video screen 16 may issue instructions to the user as to how the cash deposit is to be made. For example, the user may first be instructed to deposit all $100 dollar bills and to affirmatively indicate when all $100 dollar bills have been deposited. The process may then be repeated for $50, $20, $10, $5, $2 and $1 dollar bills. Without directly scanning the deposited bills to determine the denomination thereof, the data acquisition circuitry 39 or other type of detector may sense the number of bills deposited during the deposit of bills of each denomination and, in conjunction with the information entered at the user interface 46, may determine the number of bills of each denomination forming the cash deposit. Of course, the number of bills of each denomination forming the cash deposit may be determined by a wide variety of other techniques. In one such example, the data acquisition circuitry 39 may be configured to determine the denomination of each bill deposited into the ATM 10 as the bills are transported to the depository 36 along the conveyor system 37. In another, the user may be asked to identify each denomination of bill to be deposited in the ATM 10 and the number of bills of each identified denomination included as part of the deposit.

Continuing to refer to FIG. 2, the housing 12 further includes processor subsystem 42 and memory subsystem 44, coupled to each other and to the printer 20 and user interface 46 by bus subsystem 50. As used herein, the term “processor subsystem” encompasses the total processing capacity of the ATM 10, whether such processing capacity is embodied as a single processing device, for example, a microprocessor, multiple processing devices, for example, coprocessors, located in a single computing device, multiple processing devices residing in respective computing devices interconnected with one another or any combinations thereof. Similarly, the term “memory subsystem” encompasses the total memory capacity of the ATM 10, whether such memory capacity is embodied as main, auxiliary or other type of memory of a single computing device, main, auxiliary or other type of memory of multiple computing devices interconnected with one another, a stand-alone memory device, or any combinations thereof. Finally, the term “bus subsystem” encompasses all of the conductors and/or other types of connectors used to transfer address, data and control signals between the various components and/or devices which collectively comprise the ATM 10. Still further, the term “memory space” (as well as the terms “memory sub-space” and “memory sub-sub-space”) refers to a set of one or more contiguous or noncontiguous addresses within the memory subsystem 44, including a set of multiple addresses distributed amongst plural memory devices. However, there is no requirement that both the first and second memory spaces 45 and 47 (nor any sub-spaces or sub-sub-spaces thereof) are contiguous with any of the other memory spaces, sub-spaces or sub-sub-spaces thereof. Likewise, there is no requirement that both the first and second memory spaces 45 and 47 (nor any sub-spaces or sub-sub-spaces thereof) reside on a common memory device.

Residing on the memory subsystem is a first software module 43a, a second software module 43b, a first memory space 45 and a second memory space 47. Each of the first and second software modules 43a and 43b is comprised of a series of instructions, the execution of which will perform various types of functions, including, among others, full sweeps of the depository 36, partial sweeps of the depository 36 and resets of the ATM 10. In the embodiment disclosed herein, the first software module 43a is configured such that the processor subsystem 42 may instruct the first software module 43a to execute a full sweep or partial sweep of the depository 36 while the second software module 43b is configured such that the processor subsystem 42 may instruct the second software module 43b to execute a reset of the ATM 10. Of course, it is fully contemplated that a single software module may be employed to perform all of the aforementioned functions or, in the alternative, the functions of one or both of the first and second software module may be distributed among any number of software modules. Of course, it should be clearly understood that one or both of the first and second software modules 43a and/or 43b may include additional instructions which enable the first and/or second software module 43a and/or 43b, respectively, to perform operations other than those specifically disclosed herein.

In the past, it was only necessary to dedicate a single space of the memory subsystem to maintain the information related to deposits necessary to conduct a full settlement of an ATM. However, to conduct partial settlements of an ATM, additional functionality, e.g., full and partial sweeps of the depository 36, was needed. To perform the additional functions needed to conduct partial settlements while maintaining the existing functionality, e.g., total resets, needed to perform full settlements of the ATM, it is recommended that at least one additional memory space be dedicated to maintaining additional information related to the deposits made at the ATM 2. By configuring the memory subsystem in the manner disclosed herein, it is now possible to sweep the depository 36 to acquire the information necessary to conduct a partial settlement of the ATM 10 and later reset the ATM 10 to acquire the information to conduct a full settlement of the ATM 10. For example, as illustrated in FIG. 2, the first memory space 45 maintains information related to deposits made at the ATM 10 since the last sweep of the depository 36 while the second memory space 47 maintains information related to deposits made at the ATM 10 after the last reset of the ATM 10 but before the last sweep of the depository 36.

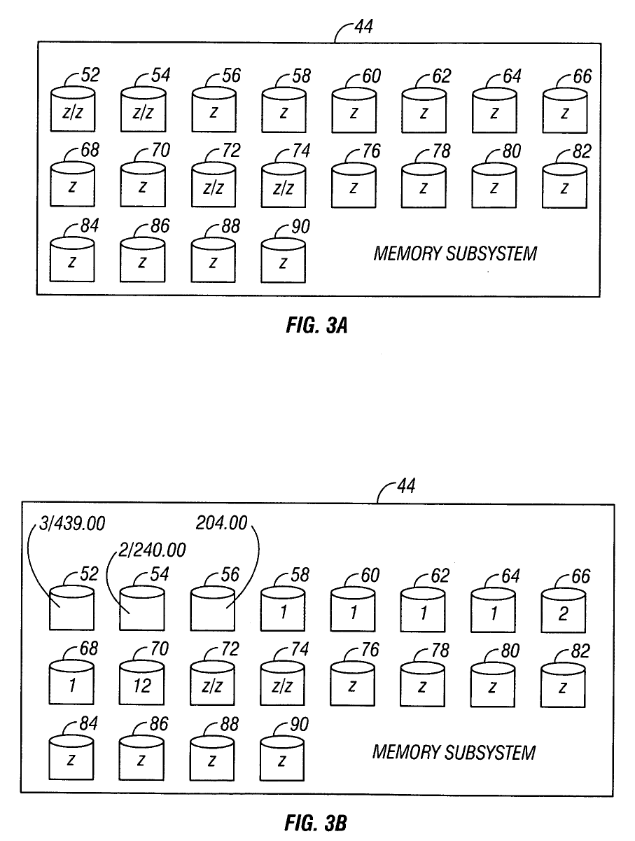

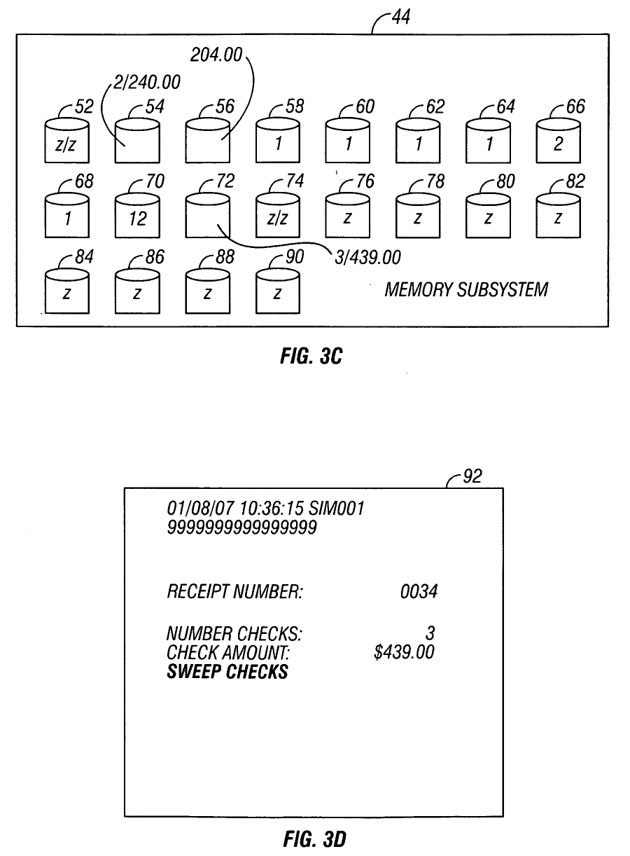

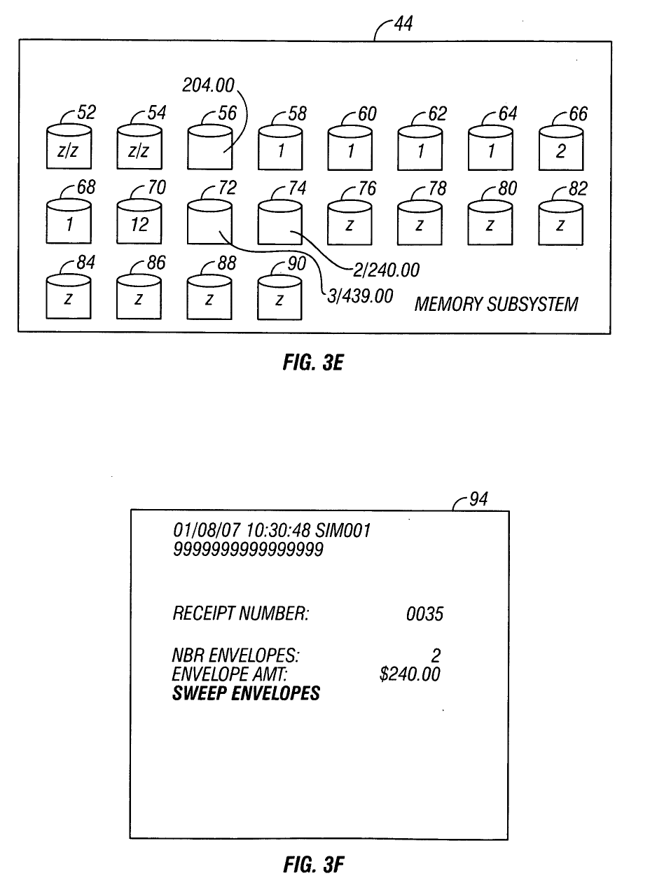

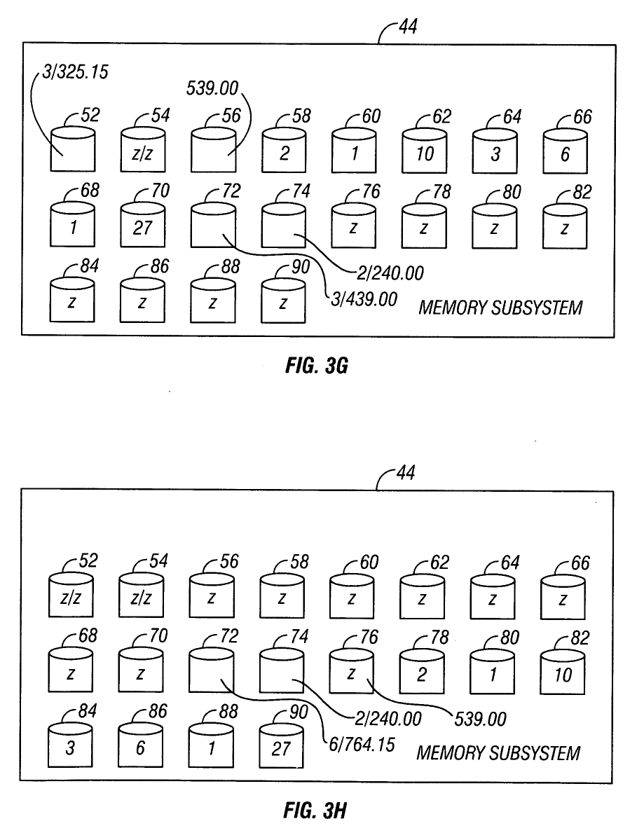

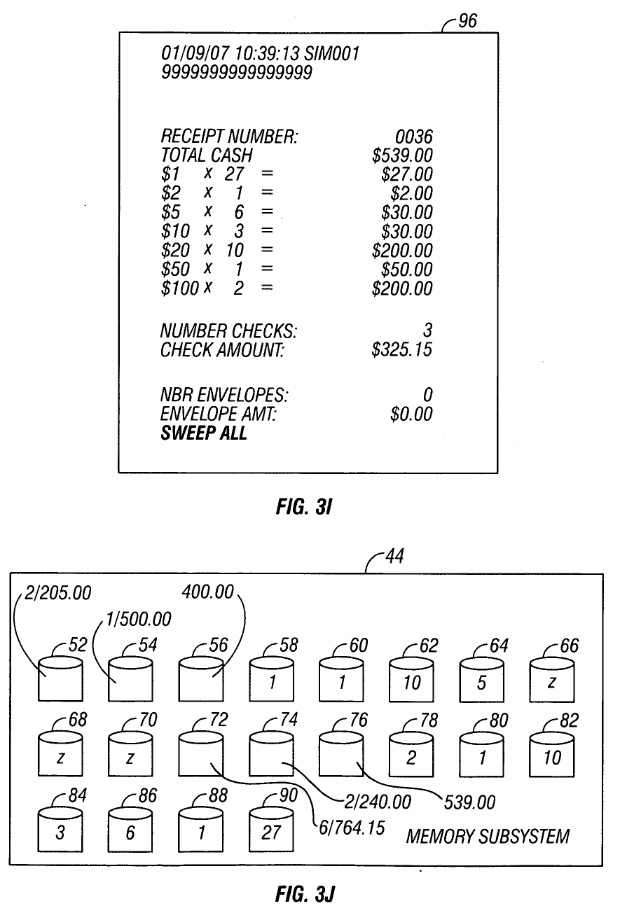

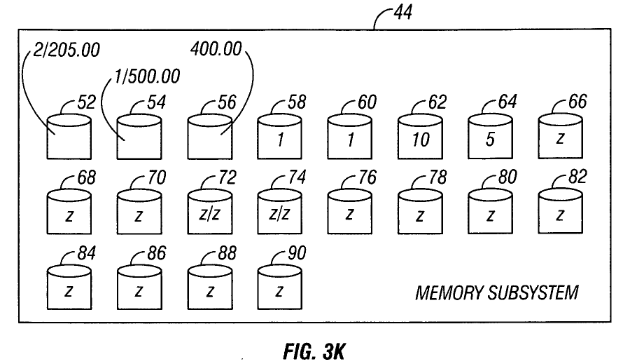

Referring next to FIGS. 3A through 3K, the process by which depository 36 is swept, thereby enabling partial settlements of the ATM 10, will now be described in greater detail. In this regard, it is noted that each of FIGS. 3A-C, FIG. 3E, FIGS. 3G-H and FIGS. 3J-K representatively illustrates the contents of a portion of the memory subsystem 44, here, the first memory space 45 and the second memory space 47. More specifically, the memory subsystem 44 includes plural “buckets” 52 through 90. Each “bucket” represents a portion of either the first memory space 45 or the second memory space 47 in which specified information is stored in an encoded format. Variously, it is contemplated that the portion of the memory subsystem corresponding to each of the buckets 52 through 90 may be a contiguous segment of memory which commences at a specified address or a series of noncontiguous segments of memory, each commencing at a respective address, coupled together by one or more pointers. It is further contemplated that the each of the buckets 52 through 90 may be comprised of a register (or a portion thereof) in which the specified information is stored.

As may be further seen in FIG. 3A, the plural buckets forming a portion of the first or second memory spaces 45 or 47 of the memory subsystem 44 are plural buckets which include a first bucket 52, a second bucket 54, a third bucket 56, a fourth bucket 58, a fifth bucket 60, a sixth bucket 62, a seventh bucket 64, an eighth bucket 66, a ninth bucket 68, a tenth bucket 70, an eleventh bucket 72, a twelfth bucket 74, a thirteenth bucket 76, a fourteenth bucket 78, a fifteenth bucket 80, a sixteenth bucket 82, a seventeenth bucket 84, an eighteenth bucket 86, a nineteenth bucket 88 and a twentieth bucket 90, of which the first, second, third, fourth, fifth, sixth, seventh, eighth, ninth and tenth buckets 52, 54, 56, 58, 60. 62. 64. 68 and 70 form part of the first memory space 45 while the eleventh, twelfth, thirteenth, fourteenth, fifteenth, sixteenth, seventeenth, eighteenth, nineteenth and twentieth buckets 72, 74, 76, 78, 80, 82, 84, 86, 88 and 90 buckets form part of the second memory space 47.

While it is fully contemplated that various portions of the information to be maintained in order to conduct either a “partial sweep” or a “full sweep” may be stored in various ones of first through twentieth buckets 52 through 90, in the embodiment disclosed herein, the information to be held in each of the first through twentieth buckets 52 through 90 is arranged in accordance with the foregoing:

TABLE I

| | |
|---|---|
| Bucket 52 | Total number of checks deposited without use of an envelope |
| | since last “Sweep Checks” or “Sweep All” Operation/Total |
| | dollar amount of checks deposited without use of an envelope |
| | since last “Sweep Checks” or “Sweep All” operation |
| Bucket 54 | Total number of envelopes deposited since last “Sweep |
| | Envelopes” or “Sweep All” operation/Total dollar amount of |
| | envelopes deposited since last “Sweep Envelopes” or “Sweep |
| | All” operation |
| Bucket 56 | Total cash deposited without use of an envelope since last |
| | “Sweep Cash” or “Sweep All” operation |
| Bucket 58 | Total number of $100 bills deposited without use of an |
| | envelope since last “Sweep Cash” or “Sweep All” operation |
| Bucket 60 | Total number of $50 bills deposited without use of an |
| | envelope since last “Sweep Cash” or “Sweep All” operation |
| Bucket 62 | Total number of $20 bills deposited without use of an |
| | envelope since last “Sweep Cash” or “Sweep All” operation |
| Bucket 64 | Total number of $10 bills deposited without use of an |
| | envelope since last “Sweep Cash” or “Sweep All” operation |
| Bucket 66 | Total number of $5 bills deposited without use of an envelope |
| | since last “Sweep Cash” or “Sweep All” operation |
| Bucket 68 | Total number of $2 bills deposited without use of an envelope |
| | since last “Sweep Cash” or “Sweep All” operation |
| Bucket 70 | Total number of $1 bills deposited without use of an envelope |
| | since last “Sweep Cash” or “Sweep All” operation |
| Bucket 72 | Total number of checks deposited without use of an envelope |
| | and swept since last “Totals Reset” operation/Total dollar |
| | amount of checks deposited without use of an envelope and |
| | swept since last “Totals Reset” operation |
| Bucket 74 | Total number of envelopes swept since last “Totals Reset” |
| | operation/Total dollar amount of envelopes swept since last |
| | “Totals Reset” operation |
| Bucket 76 | Total cash deposited without use of an envelope and swept |
| | since last “Totals Reset” operation |
| Bucket 78 | Total number of $100 bills deposited without use of an |
| | envelope and swept since last “Totals Reset” operation |
| Bucket 80 | Total number of $50 bills deposited without use of an |
| | envelope and swept since last “Totals Reset” operation |
| Bucket 82 | Total number of $20 bills deposited without use of an |
| | envelope and swept since last “Totals Reset” operation |
| Bucket 84 | Total number of $10 bills deposited without use of an |
| | envelope and swept since last “Totals Reset” operation |
| Bucket 86 | Total number of $5 bills deposited without use of an envelope |
| | and swept since last “Totals Reset” operation |
| Bucket 88 | Total number of $2 bills deposited without use of an envelope |
| | and swept since last “Totals Reset” operation |
| Bucket 90 | Total number of $1 bills deposited without use of an envelope |
| | and swept since last “Totals Reset” operation |

Of course, while, in the embodiment set forth in Table I indicates that first, second, eleventh and twelfth buckets 52, 54, 72 and 74 each maintain multiple types of information, e.g., the number of a particular item deposited in the ATM 10 and the total value of the deposited items, it should be noted that additional buckets may be provided and that each type of information may be instead by maintained in a discrete bucket.

FIG. 3A is employed as a starting point for describing the depository sweep process. At this stage, the ATM 10 is in service and is ready to perform banking transactions such as cash withdrawals from accounts, deposits of cash and/or checks into accounts, balance inquiries, transfers between accounts as well as a wide variety of other banking transactions. The contents each of the first through twentieth buckets 52 through 90, including all of the buckets 52 through 70 forming part of the first memory space 45 and all of the buckets 72 through 90 forming part of the second memory space 47, are empty, e.g., the buckets have zero (“z”) contents. In this regard, it should be noted that all of the first through twentieth buckets 52 through 90 are empty under only two specific sets of conditions-the first being at an initial startup of the ATM 10 and the second being immediately subsequent to a sweep of the depository 36 using the sweep all command which, in turn, is immediately subsequent to a reset of the ATM 10 using a “totals reset” command.

Over time, the transactions conducted at the ATM 10 include a number of deposits. For each deposit made using the ATM 10, information related to the deposit is stored in the first group of buckets 52 through 70. In the example illustrated in FIG. 3B, the contents of the first bucket 52 is 3/439.00. This indicates that, in the period of time that has elapsed, three checks have been deposited into the ATM 10 without the use of envelopes and that the customer(s) depositing the checks have indicated that the value of the three checks totals $439.00. FIG. 3B further indicates that the contents of the second bucket 54 is 2/240.00. This indicates that, in the relevant time period, two envelopes have been deposited and that the customer(s) depositing the envelopes have indicated that the value of the cash and/or checks in the envelopes is $240.00. The third bucket 56 indicates that $204.00 in cash has been deposited in the ATM 10 without the use of envelopes and the fourth through tenth buckets 58 through 70 indicate that the $204.00 deposited in the ATM 10 is comprised of one $100 bills (as indicated by the fourth bucket 58), one $50 bill (as indicated by the fifth bucket 60), one $20 bill (as indicated by the sixth bucket 62), one $10 bill (as indicated by the seventh bucket 64), two $5 bills (as indicated by the eighth bucket 66), one $2 bill (as indicated by the ninth bucket 68) and twelve $1 bills (as indicated by the tenth bucket 70). Of course, the deposits described in FIG. 3B are provided purely by way of example and it is fully contemplated that the deposits may be comprised of a greater or lesser number of one or more of each type of deposit, e.g., checks, envelopes and cash, a greater or lesser total dollar amount for one or more of each type of deposit and/or a greater or lesser number of bills of one or more of each one of the possible denominations thereof.

FIG. 3C illustrates the results of a first partial sweeps operation, here, a “sweep checks” operation if executed when the memory subsystem 44 maintaining information related to the contents of the depository 36 is configured in the manner illustrated in FIG. 3B. In order to initiate this type of operation, the bank employee or other servicer of the ATM 10 issues an appropriate command via the user interface 46. For example, the bank employee would first log in, typically, by inserting a card recognizable to the processor subsystem 42 as a supervisor card into the slot. In response to a request generated by the processor subsystem 42, the supervisor would then enter a secret code, similar to a pin code, which authenticates the person entering the code as the person to which the supervisor card is assigned. The supervisor would then scroll through a series of menu until the processor subsystem 42 generates, on the video screen 16, a display from which the supervisor is capable of issuing the “sweep checks” command, for example, by the video screen 16 indicating that depression of a specified key will initiate a “sweep checks” operation.

In response to issuance of the “sweep checks” command by the user interface 46, the processor subsystem 42 executes instructs the first software module 43a to initiate the requested partial sweep of the depository 36. In response to issuance of the “sweep checks” command, the first software module 43a executes the following actions: (1) sums the contents of the first bucket 52 with the contents of the eleventh bucket 72; (2) replaces the contents of the eleventh bucket 72 with the sum of the first and eleventh buckets 52 and 72; (3) generates an output which summarizes the contents of the first bucket 52; (4) instructs the printer 20 to generate a hard copy of the report; and (5) clears the contents of the first bucket 52. Accordingly, as illustrated in FIG. 3C, the first bucket 52 is now empty and the contents of the eleventh bucket 72 is now equal to the contents of the first bucket 52 prior to issuance of the “sweep checks” command, thereby indicating that three checks totaling $439.00 have been swept from the depository since the last “totals reset” of the ATM 10. Of course, if prior to issuance of the “sweep checks” command, the eleventh bucket 72 had not been empty, for example, if the contents of the eleventh bucket 72 was 1/100.00 (indicating that 1 check in the amount of $100.00 had been deposited since the last totals reset of the ATM 10, the contents of the eleventh bucket 72 would have been greater than the contents of the first bucket 52, e.g., in the provided example, the contents of the eleventh bucket 72 would have been 4/539.00. Further, it should be clearly understood that the order in which the first software module 43a executes actions (1) through (5) is set forth purely by way of example and it is fully contemplated that the actions may be executed in orders other than that specifically recited herein.

FIG. 3D illustrates a printout 92 generated by the printer 20 of the ATM 10 as part of the “sweep checks” operation. As may be clearly seen, the printout 92 identifies the date and time of the sweep of checks from the depository 36. The printout 92 further identifies the number of checks swept and the total amount of those checks since the last issuance of either a “sweep checks” or “sweep all” command. Again, it should be clearly understood that the particular information set forth on the printout 92 is provided purely by way of example and that the first software module 43a may instead be configured to provide additional information and/or not provide some of the information appearing on the printout 92. Preferably, however, the printout 92 should contain the scope of the sweep executed, e.g., that three checks totaling $439.00 have been swept from the depository 36, as the foregoing information is particularly useful when partially settling the ATM 10. Further, the printout 92 could be used to identify the number and total amount of the checks removed from the depository 36 by the supervisor immediately prior/subsequent to issuance of the “sweep checks” command or, if the supervisor elects not to remove the checks from the depository 36 (or, in the alternative, is not authorized to remove the checks) to determine when removal of the checks from the depository 36 should be scheduled. Still further, it should be clearly understood that the printer 20 is but one manner by which the swept information may be transmitted and that the swept information may be transmitted by techniques or devices other than those disclosed herein. Finally, it is contemplated that the swept information may be transmitted in either a tangible or intangible form.

Referring next to FIG. 3E, a second partial sweep operation, here, a “sweep envelopes” operation conducted immediately subsequent to the “sweep checks” operation described with respect to FIGS. 3B-D shall now be described. The “sweep envelopes” operation is initiated, typically, in the same manner as the “sweep checks” operation. More specifically, in response to issuance of a “sweep envelopes” command by the user interface 46, the processor subsystem 42 executes the “sweep envelopes” operation by instructing the software module 43a to initiate the requested type of partial sweep of the depository 36. In response thereto, the first software module 43a executes the following actions: (1) sums the contents of the second bucket 54 with the contents of the twelfth bucket 74; (2) replaces the contents of the twelfth bucket 74 with the sum of the second twelfth buckets 54 and 74; (3) generates an output which summarizes the contents of the second bucket 54; (4) instructs the printer 20 to generate a hard copy of the output summarizing the contents of the second bucket 54; and (5) clears the contents of the second bucket 54. Accordingly, as illustrated in FIG. 3E, the second bucket 54 is now empty and, as the twelfth bucket 74 was empty prior to the issuance of the “sweep envelopes” command, the contents of the twelfth bucket 74 is now equal to the contents of the second bucket 54, e.g., the twelfth bucket 74 indicates that two envelopes containing $240.00 in checks and/or currency have been swept from the depository 36 since the last “totals reset” of the ATM 10f. Of course, if prior to issuance of the sweep checks command, the twelfth bucket 74 had not been empty, for example, if the contents of the twelfth bucket 74 was 1/100.00 (indicating that 1 envelope containing checks and/or cash totaling $100.00 had been deposited since the last totals reset of the ATM 10, the contents of the twelfth bucket 74 would have been greater than the contents of the second bucket 54, e.g., in the provided example, the contents of the twelfth bucket 74 would have been 3/340.00 (indicating that 3 envelopes containing checks and/or cash totaling $340 had been deposited in the ATM 10 since the last totals reset thereof. Further, it should be clearly understood that the order that the first software module 43a executes actions (1) through (5) is set forth purely by way of example and it is fully contemplated that the actions may be executed in orders other than that specifically recited herein.

Turning next to FIG. 3F, a printout 94 generated by the printer 20 of the ATM 10 during execution of the “sweep checks” operation will now be described in greater detail. As may be clearly seen, the printout 94 identifies the date and time of the sweep of envelopes from the depository 36. The printout 94 further identifies the number of envelopes swept and the total amount of those envelopes since the last issuance of either a “sweep envelopes” or “sweep all” command. Again, it should be clearly understood that the particular information set forth on the printout 94 is provided purely by way of example and that the first software module 43a may instead be configured to provide additional information and/or not provide some of the information appearing on the printout 94. Preferably, however, the printout 92 should contain the scope of the sweep, e.g., two envelopes totaling $240.00 have been swept from the depository 36 as the foregoing information is particularly useful when partially settling the ATM 10. Further, the printout 94 could again be used to identify the number and total amount of the envelopes removed from the depository 36 by the supervisor immediately prior/subsequent to issuance of the “sweep envelopes” command or, if the supervisor elects not to remove the envelopes from the depository 36 (or, in the alternative, is not authorized to remove the envelopes) to determine when removal of the envelopes from the depository 36 should be scheduled.

Referring next to FIG. 3G, the contents of the memory subsystem 44 reflect continued use of the ATM 10 by customers of the bank. More specifically, since being cleared upon execution of the “sweep checks” command, an additional three checks totaling $325.15 have been deposited. Thus, taken together, the first and eleventh buckets 52 and 72 of the memory subsystem 44 now indicate that 3 checks totaling $325.15 have been deposited since the last “sweep checks” and an additional 3 checks totaling $439 have been deposited since the last “totals reset” of the ATM 10. The contents of the memory subsystem 44 further reflect that additional cash has been deposited in the ATM 10. Specifically, an additional $335 comprised of one $100 bill, nine $20 bills, two $10 bills, four $5 bills and fifteen $1 bills have been deposited in the ATM 10 since execution of the “sweep checks” command.

Referring next to FIG. 3H, execution of a full sweep (or “sweep all”) command will now be described in greater detail. The “sweep all” operation is initiated, typically, in the same manner as both the “sweep checks” and “sweep envelopes” operations. More specifically, in response to issuance of a “sweep all” command by the user interface 46, the processor subsystem 42 executes the “sweep all” command by instructing the memory subsystem 43a to initiate the requested full depository sweep. In response thereto, the first software module 43a executes the following actions: (1) sums the contents of the first bucket 52 and the eleventh bucket 72; (2) sums the contents of the second bucket 54 and the twelfth bucket 74; (3) sums the contents of the third, fourth, fifth, sixth, seventh, eighth, ninth and tenth buckets 56, 58, 60, 62, 64, 66, 68 and 70 with the contents of the thirteenth, fourteenth, fifteenth, sixteenth, seventeenth, eighteenth, nineteenth and twentieth buckets 76, 78, 80, 82, 84, 86, 88 and 90, respectively; (4) replaces the contents of the eleventh bucket 72 with the sum of the first and eleventh buckets 52 and 72; (5) replaces the contents of the twelfth bucket 74 with the sum of the second and twelfth buckets 54 and 74; (6) replaces the contents of the thirteenth, fourteenth, fifteenth, sixteenth, seventeenth, eighteenth, nineteenth and twentieth buckets 76, 78, 80, 82, 84, 86, 88 and 90 with the sum of the third and thirteenth buckets 56 and 76, fourth and fourteenth buckets 58 and 78, fifth and fifteenth buckets 60 and 80, sixth and sixteenth buckets 62 and 82, seventh and seventeenth buckets 74 and 84, eighth and eighteenth buckets 76 and 86, ninth and nineteenth buckets 78 and 88 and tenth and twentieth buckets 80 and 90, respectively; (7) generates an output which summarizes the contents of the first through tenth buckets 52 through 70; (8) instructs the printer 20 to generate a hard copy of the output summarizing the contents of the first through tenth buckets 52 through 70; and (9) clears the contents of the first through tenth buckets 52 through 70. Accordingly, as illustrated in FIG. 3H, the first through tenth buckets 52 through 70 are now empty. As the thirteenth through twentieth buckets 76 through 90 were empty prior to the issuance of the “sweep all” command, the contents of the thirteenth through twentieth buckets 76 through 90 are now equal to the prior contents of the third through tenth buckets 52 and 56 through 70, respectively, e.g., the thirteenth through twentieth buckets 76 through 90 indicate that $539 comprised of two one hundred dollar bills, one fifty dollar bill, ten twenty dollar bills, three ten dollar bills, six five dollar bills, one two dollar bill and twenty-seven one dollar bills have been deposited in the ATM 10 since issuance of the last “sweep all” command.

In contrast, prior to issuance of the “sweep all” command, neither the first bucket 52 nor the tenth bucket 72 were empty. Specifically, the contents of the first bucket 52 were 3/325.15 while the contents of the tenth bucket 72 were 3/439.00. The contents of the first bucket 52 indicates that 3 checks totaling $325.15 had been deposited in the ATM 10 since the last issuance of either a “sweep checks” or “sweep all” command while the contents of the tenth bucket 72 indicates that 3 checks totaling $439.00 had been deposited in the ATM 10 since issuance of the last “totals reset” command but prior to issuance of the last “sweep checks” or “sweep all” command. Finally, prior to issuance of the “sweep all” command, the contents of the second bucket 54 was empty while the contents of the twelfth bucket 74 were 2/240.00. The foregoing indicates that two envelopes totaling $240.00 were deposited in the ATM 10 since issuance of the last “totals reset” command but that no envelopes had been deposited in the ATM since issuance of the last “sweep envelopes” or “sweep all” command. As a result, the contents of both the second bucket 54 and the twelfth bucket 74 are unchanged in spite of issuance of the “sweep all” command.

Of course, if prior to issuance of the sweep cash command, the thirteenth through twentieth buckets 76 through 90 had not been empty, for example, if the contents of the thirteenth bucket was 188 and the contents of each one of the fourteenth through twentieth buckets 78 through 90 were one (indicating that $188 of cash comprised of one $100 bill, one $50 bill, one $20 bill, one $10 bill, one $5 bill, one $2 bill and one $1 bill had been deposited since the last totals reset of the ATM 10, the contents of each of the thirteenth through twentieth buckets 76 through 90 would have been greater than the contents of the third through tenth buckets 56 through 70, e.g., in the provided example, the contents of the thirteenth through twentieth buckets 76 through 90 would have been 727, 3, 2, 11, 4, 7, 2 and 28, respectively, indicating that $727 comprised of three $100 bills, two $50 bills, eleven $20 bills, four $10 bills, seven $5 bills, two $2 bills and twenty-eight $1 bills had been deposited in the ATM 10 since the last totals reset thereof. Further, it should be clearly understood that the order that the first software module 43a executes actions (1) through (9) is set forth purely by way of example and it is fully contemplated that the actions may be executed in orders other than that specifically recited herein.

FIG. 3I illustrates a printout 96 generated by the printer 48 of the ATM 10 during execution of the “sweep all” operation. As may be clearly seen, the printout 94 identifies the date and time at which the “sweep all” operation was conducted. The printout 96 further indicates (1) the number of envelopes and the combined value of the envelopes deposited since execution of either the last “sweep envelopes” or “sweep all” operation; (2) the number of checks and the combined value of the checks deposited since execution of either the last “sweep checks” or “sweep all” operation; and (3) the amount of cash and a breakdown of the cash by denomination deposited since execution of the previous “sweep cash” or “sweep all” operation. Again, it should be clearly understood that the particular information set forth on the printout 96 is provided purely by way of example and that the first software module 43a may instead be configured to provide additional information and/or not provide some of the information appearing on the printout 96. Preferably, however, the printout 96 should contain the scope of the sweep, e.g., no envelopes, three checks totaling $325.15 and cash totaling $539.00, the cash being comprised of two $100 bills, one $50 bill, ten $20 bills, three $10 bills, six $5 bills, one $2 bill and twenty-seven $1 bills as the foregoing information is particularly useful when partially reconciling the ATM 10.Further, the printout 96 could again be used to identify the number and total value envelopes, checks and cash removed from the depository 36 by the supervisor as part of the partial settlement of the ATM 10 conducted by issuance of the “sweep all” command or, if the supervisor elects not to remove the envelopes, checks and cash from the depository 36 (or, in the alternative, is not authorized to remove the envelopes, checks and cash from the depository 36), the printout 96 may be used to determine when removal of the checks, envelopes and cash from the ATM 10 should be scheduled.

While not specifically shown in the drawings, execution of the “sweep cash” operation may be readily discerned by the foregoing description. More specifically, the results of conducting a “sweep cash” operation may be viewed as the results of conducting a “sweep all” operation less the results of conducting “sweep checks” and “sweep envelopes” operations.

Referring next to FIG. 3J, the contents of the memory subsystem 44 reflect continued use of the ATM 10 by customers of the bank. More specifically, since being cleared upon execution of the “sweep all” command, an additional two envelopes totaling $205.00, a check for $500 and $400 in cash comprised of one $100 bill, one $50 bill, ten $20 bills and five $10 bills have been deposited in the ATM 10. Thus, the first and eleventh buckets 52 and 72 of the memory subsystem 44 collectively indicate that two envelopes totaling $205 have been deposited since conducting either the last “sweep envelopes” or “sweep all” operation 10 and that an additional six envelopes totaling $764.15 have been deposited since the last “totals reset” of the ATM 10. Similarly, the second and twelfth buckets 3 and 13 collectively indicate that one check in the amount of $500.00 has been deposited since conducting either the last “sweep checks” or “sweep all” operation and an additional two checks totaling $240.00 have been deposited since the last “totals reset” of the ATM 10. Finally, the third through tenth and thirteenth through twentieth buckets 58 through 70 and 76 through 90 collectively indicate that $400 in cash comprised of one $100 bill, one $50 bill, ten $20 bills and five $10 bills have been deposited since conducting either the last “sweep cash” or “sweep all” operation and that an additional $539 comprised of two $100 bills, one $50 bill, ten $20 bills, three $5 bills, one $2 bill and 27 $1 bills have been deposited since the last “totals reset” of the ATM 10.

Referring next to FIG. 3K, execution of a “totals reset” command will now be described in greater detail. Prior to execution of the “totals reset” command, and as previously set forth with respect to FIG. 3J, the contents of the eleventh bucket 72 indicates that 6 envelopes totaling $764.15 have been deposited into the ATM 10 in the period between the last “totals reset” operation and the last “sweep envelopes” or “sweep all” operation, 2 checks totaling $240.00 have been deposited into the ATM 10 in the period between the last “totals reset” operation and the last “sweep checks” or “sweep all” operation and $400 in cash comprised of one $100 bill, one $50 bill, ten $20 bills and five $10 bills have been deposited in the ATM 10 in the period between the last “totals reset” operation and the last “sweep cash” or “sweep all” operation.

The “totals reset” operation is initiated, typically, in the same manner as the “sweep checks”, “sweep envelopes” and “sweep cash” operations. More specifically, in response to issuance of a “totals reset” command by the user interface 46, the processor subsystem 42 executes the “totals reset” command by instructing the second software module 43b to initiate the requested reset of the ATM 10. In response thereto, the second software module 43b executes the following actions: (1) generates an output summarizing the contents of the buckets 72 through 90; (2) instructs the printer 20 to generate a hard copy of the output summarizing the contents of the buckets 72 through 90; and (3) clears the contents of the eleventh through twentieth buckets 72 through 90. Accordingly, as illustrated in FIG. 3K, the eleventh through twentieth buckets 72 through 90 are now empty. Of course, it should be clearly understood that the order that the second software module 43a executes actions (1) through (3) is set forth purely by way of example and it is fully contemplated that the actions may be executed in orders other than that specifically recited herein.

However, information related to deposits made subsequent to: (1) the last “sweep envelopes or “sweep all” operation (for the first bucket 52); (2) the last “sweep checks” or “sweep all” operation (for the second bucket 54); or (3) the last “sweep cash” or “sweep all” operation (for the third through tenth buckets 56 through 70) remains in the first, second and/or third through tenth buckets 52, 54 and/or 56 through tenth bucket 70, respectively. Thus, the contents of the first through tenth buckets 52 through 70 continue to reflect that an additional two envelopes totaling $205.00, a check for $500 and $400 in cash comprised of one $100 bill, one $50 bill, ten $20 bills and five $10 bills have been deposited in the ATM 10 since the last “sweep all” operation previously described with respect to FIGS. 3G through 3I.

While a number of embodiments of a method for sweeping the depository of an ATM such that a partial reconciliation of the ATM and/or clearance of non-cash deposits may be expedited and an ATM configured for the same have been shown and described herein, modifications thereof may be made by one skilled in the art without departing from the spirit and the teachings of the invention. The embodiments described herein are exemplary only, and are not intended to be limiting. Many variations, combinations, and modifications of the embodiments disclosed herein are possible and are within the scope of the teachings set forth herein. Accordingly, the scope of protection is not limited by the description set out above but is only defined by the claims appended hereto

1. An automatic teller machine (ATM), comprising:
a depository; and
a memory subsystem configured to store data describing deposits of funds into said depository of said ATM;
said memory subsystem including first and second memory spaces, said first memory space storing data describing deposits conducted subsequent to a first sweep of said depository of said ATM and prior to a second sweep of said depository of said ATM and said second memory space storing data describing deposits conducted subsequent to a first reset of said ATM and prior to said second sweep of said ATM.

2. The ATM of claim 1, and further comprising a processor subsystem configured to sum the contents of said first memory space with the contents of said second memory space and stored the sum in said second memory space.

3. The ATM of claim 1, and further comprising:
a user interface for (1) entering said data describing deposits into said depository of said ATM; (2) initiating sweeps of said depository of said ATM; and (3) initiating resets of said ATM.

4. The ATM of claim 1, wherein:
said first memory space further comprises a first memory sub-space in which data describing envelope deposits conducted subsequent to said first sweep of said depository and prior to said second sweep of said depository is stored, a second memory sub-space in which data describing non-envelope check deposits conducted subsequent to said first sweep of said depository and prior to said second sweep of said depository is stored and a third memory sub-space in which data describing non-envelope cash deposits conducted subsequent to said first sweep of said depository and prior to said second sweep of said depository is stored; and
said second memory space further comprises a first memory sub-space in which data describing envelope deposits conducted subsequent to said first reset of said ATM and prior to said second sweep of said ATM is stored, a second memory sub-space in which data describing non-envelope check deposits conducted subsequent to said first reset of said ATM and prior to said second sweep of said ATM is stored and a third memory sub-space in which data describing non-envelope cash deposits conducted subsequent to said first reset of said ATM and prior to said second sweep of said ATM is stored.

5. The ATM of claim 4, wherein said third memory sub-space of said first memory space further comprises:
a first memory sub-sub-space in which data describing the total amount of cash deposited during said non-envelope cash deposits conducted subsequent to said first sweep of said depository and prior to said second sweep of said depository is stored;
a second memory sub-sub-space in which data identifying the total number of one dollar bills deposited during said non-envelope cash deposits conducted subsequent to said first sweep of said depository and prior to said second sweep of said depository is stored;
a third memory sub-sub-space in which data identifying the total number of two dollar bills deposited during said non-envelope cash deposits conducted subsequent to said first sweep of said depository and prior to said second sweep of said depository is stored;
a fourth memory sub-sub-space in which data identifying the total number of five dollar bills deposited during said non-envelope cash deposits conducted subsequent to said first sweep of said depository and prior to said second sweep of said depository is stored;
a fifth memory sub-sub-space in which data identifying the total number of ten dollar bills deposited during said non-envelope cash deposits conducted subsequent to said first sweep of said depository and prior to said second sweep of said depository is stored;
a sixth memory sub-sub-space in which data identifying the total number of twenty dollar bills deposited during said non-envelope cash deposits conducted subsequent to said first sweep of said depository and prior to said second sweep of said depository is stored;
a seventh memory sub-sub-space in which data identifying the total number of fifty dollar bills deposited during said non-envelope cash deposits conducted subsequent to said first sweep of said depository and prior to said second sweep of said depository is stored; and
an eighth memory sub-sub-space in which data identifying the total number of one hundred dollar bills deposited during said non-envelope cash deposits conducted subsequent to said first sweep of said depository and prior to said second sweep of said depository is stored.

6. The ATM of claim 5, wherein said third memory sub-space of said second memory space further comprises:
a first memory sub-sub-space in which data describing the total amount of cash deposited during said non-envelope cash deposits conducted subsequent to said first reset of said ATM and prior to said second sweep of said ATM is stored;
a second memory sub-sub-space in which data identifying the total number of one dollar bills deposited during said non-envelope cash deposits conducted subsequent to said first reset of said ATM and prior to said second sweep of said ATM is stored;
a third memory sub-sub-space in which data identifying the total number of two dollar bills deposited during said non-envelope cash deposits conducted subsequent to said first reset of said ATM and prior to said second sweep of said ATM is stored;
a fourth memory sub-sub-space in which data identifying the total number of five dollar bills deposited during said non-envelope cash deposits conducted subsequent to said first reset of said ATM and prior to said second sweep of said ATM is stored;
a fifth memory sub-sub-space in which data identifying the total number of ten dollar bills deposited during said non-envelope cash deposits conducted subsequent to said first reset of said ATM and prior to said second sweep of said ATM is stored;
a sixth memory sub-sub-space in which data identifying the total number of twenty dollar bills deposited during said non-envelope cash deposits conducted subsequent to said first reset of said ATM and prior to said second sweep of said ATM is stored;
a seventh memory sub-sub-reset in which data identifying the total number of fifty dollar bills deposited during said non-envelope cash deposits conducted subsequent to said first reset of said ATM and prior to said second sweep of said ATM is stored; and
an eighth memory sub-sub-space in which data identifying the total number of one hundred dollar bills deposited during said non-envelope cash deposits conducted subsequent to said first reset of said ATM and prior to said second sweep of said ATM is stored.

7. A computer system for use in conjunction with an automatic teller machine (ATM), said computer system comprising:
a processor subsystem;
a memory subsystem, said memory subsystem including first and second memory spaces;
a bus subsystem, said processor subsystem coupled to said memory subsystem by said bus subsystem; and
a software module, said software module stored in said memory subsystem and executable by said processor subsystem;
wherein processor subsystem stores information related to said deposit in said first memory space for each deposit made at said ATM; and
wherein, upon receipt of a command from said processor subsystem, said software module sweeps the contents of at least a portion of said first memory space by summing the swept portion of said first memory space with a corresponding portion of said second memory space, stores the sum in said corresponding portion of said second memory space and clears the contents of said at least a portion of said first memory space upon receipt of a first sweep command.

8. The computer system of claim 7, and further comprising:
an output device coupled to said bus subsystem;
wherein said software module generates an output describing the contents of said at least a portion of said first memory space and transfers said first output to said output device for generation of a message describing the contents of said at least a portion of said first memory space upon receipt of said sweep command.

9. The computer system of claim 8, wherein said at least a portion of said first memory space describes all envelope deposits conducted prior to issuance of said first sweep command and subsequent to issuance of an immediately preceding sweep command.

10. The computer system of claim 8, wherein said at least a portion of said first memory space describes all non-envelope check deposits conducted prior to issuance of said sweep command and subsequent to issuance of an immediately preceding sweep command.

11. The computer system of claim 8, wherein said at least a portion of said first memory space describes all non-envelope cash deposits conducted prior to issuance of said first sweep command and subsequent to issuance of an immediately preceding sweep command.

12. The computer system of claim 7, and further comprising:
an output device coupled to said bus subsystem;
wherein said first sweep command is a full sweep command; and
wherein said software module generates a first output describing the contents of said first memory space, transfers said first output to said output device for generation of a message describing the contents of said first memory space, sums the contents of said first memory space with the contents of said second memory space, stores the sum in said second memory space and clears the contents of said first memory space upon receipt of said full sweep command.

13. The computer system of claim 12, wherein:
said software module generates a second output describing the contents of a first selected portion of said first memory space, transfers said second output to said output device for generation of a message describing the contents of said first selected portion of said first memory space, sums the contents of said first selected portion of said first memory space with a corresponding first portion of said second memory space, stores the sum in said corresponding first portion of said second memory space and clears the contents of said first selected portion of said first memory space upon receipt of a first partial sweep command of a first type;
said software module generates a third output describing the contents of a second selected portion of said first memory space, transfers said third output to said output device for generation of a message describing the contents of said second selected portion of said first memory space, sums the contents of said second selected portion of said first memory space with a corresponding second portion of said second memory space, stores the sum in said corresponding second portion of said second memory space and clears the contents of said second selected portion of said first memory space upon receipt of a partial sweep command of a second type; and
said software module generates a fourth output describing the contents of a third selected portion of said first memory space, transfers said fourth output to said output device for generation of a message describing the contents of said third selected portion of said first memory space, sums the contents of said third selected portion of said first memory space with a corresponding third portion of said second memory space, stores the sum in said corresponding third portion of said second memory space and clears the contents of said third selected portion of said first memory space upon receipt of a partial sweep command of a third type.

14. The computer system of claim 13 wherein:
said first selected portion of said first memory space describes all envelope deposits conducted prior to issuance of said partial sweep command of said first type and subsequent to issuance of an immediately preceding sweep command, said immediately preceding sweep command being either a full sweep command or a partial sweep command of said first type;
said second selected portion of said first memory space describes all non-envelope check deposits conducted prior to issuance of said partial sweep command of said second type and subsequent to issuance of an immediately preceding sweep command, said immediately preceding sweep command being either a full sweep command or a partial sweep command of said second type; and
said third selected portion of said first memory space describes all non-envelope cash deposits conducted prior to issuance of said partial sweep command of said third type and subsequent to issuance of an immediately preceding sweep command, said immediately preceding sweep command being either a full sweep command or a partial sweep command of said third type.

15. A computer system for use in conjunction with an automatic teller machine (ATM), said computer system comprising:
a processor subsystem;
a memory subsystem, said memory subsystem including first and second memory spaces;
a bus subsystem, said processor subsystem coupled to said memory subsystem by said bus subsystem;
an output device coupled to said bus subsystem;
a first software module, said first software module stored in said memory subsystem and executable by said processor subsystem;
a second software module, said second software module stored in said memory subsystem and executable by said processor subsystem;
wherein:
for each deposit made at said ATM, said processor subsystem stores information related to said deposit in said first memory space;
upon receipt of a full sweep command, said first software module generates a first output describing the contents of said first memory space, transfers said first output to said output device for generation of a message describing the contents of said first memory space, sums the contents of said first memory space with the contents of said second memory space, stores the sum in said second memory space and clears the contents of said first memory space; and
upon receipt of a reset command, said second software module generates a second output describing the contents of said second memory space, transfers said second output to said output device for generation of a message describing the contents of said second memory space and clears the contents of said second memory space.

16. The computer system of claim 15, wherein:
upon receipt of a partial sweep command, said first software module generates a third output describing the contents of a selected portion of said first memory space, transfers said third output to said output device for generation of a message describing the contents of said selected portion of said first memory space, sums the contents of said selected portion of said first memory space with the contents of a corresponding portion of said second memory space, stores the sum in said corresponding portion of second memory space and clears the contents of said corresponding portion of said first memory space.

17. A software program, comprising:
a first set of instructions encoded in a memory subsystem of an automatic teller machine (ATM) and executable by a processor subsystem of said ATM; and
a second set of instructions encoded in said memory subsystem of said ATM and executable by said processor subsystem of said ATM;
wherein:
execution of said first set of instructions causes said processor subsystem to generate a first output comprised of a summary of all deposits at said ATM subsequent to an immediately prior execution of said first set of instructions; and
execution of said second set of instructions causes said processor subsystem to generate a second output comprised of a summary of all deposits at said ATM that are both prior to said execution of said second set of instructions and subsequent to said execution of said first set of instructions.

18. The software program of claim 17, wherein said first output is generated from information stored at a first location in said memory subsystem and said second output is generated from information stored at a second location in said memory subsystem.

19. The software program of claim 18, wherein execution of said first set of instructions further causes said processor subsystem to sum said information stored at said first location with said information stored at said second location and store said sum at said second location.

20. The software program of claim 19, wherein execution of said first set of instructions further causes said processor subsystem to clear said information stored at said first memory location and execution of said second set of instructions further causes said processor subsystem to clear said information stored at said second memory location.

21. A method for collecting information related to deposits made at an automatic teller machine (ATM), comprising:
collecting information describing each deposit made at said ATM;
producing a first summary of deposits from said collected information, said first summary of deposits updated each time that a deposit is made at said ATM;
generating a first output comprised of a selected portion of said first summary of deposits;
producing a second summary of deposits from said selected portion of said first summary of deposits, said second summary of deposits updated each time that a portion of said first summary of deposits is selected;
deleting said selected portion from said first summary of deposits; and
generating a second output comprised of said second summary of deposits.

22. The method of claim 21, and further comprising deleting said second summary of deposits.

23. The method of claim 22, wherein said first summary of deposits is comprised of first, second and third sections and wherein generating an output of a selected portion of said first summary of deposits further comprises generating an output comprised of one or more of said first, second and third sections of said first summary of deposits.

24. The method of claim 23, wherein said first section of said first summary of deposits describes envelope deposits made at said ATM, said first section of said first summary describes non-envelope check deposits made at said ATM and said third section of said first summary describes non-envelope cash deposits made at said ATM.
